(19) United States
(12) Patent Application Publication
(10) Pub. No.: US 2018/0062719 A1
(43) Pub. Date: Mar. 1, 2018

(54) MODALITIES TO TRIGGER AIR-INTERFACE BEAMFORMING IN VIRTUAL REALITY USE CASES

(71) Applicant: QUALCOMM Incorporated, San Diego, CA (US)

(72) Inventors: Lochan Verma, San Diego, CA (US); Mina Ayman Saleh Yanni Makar, San Diego, CA (US); Vijayalakshmi Rajasundaram Raveendran, Del Mar, CA (US)

(21) Appl. No.: 15/249,059

(22) Filed: Aug. 26, 2016

(51) Int. Cl. H04B 7/06; H04L 12/26; H04W 72/04

(52) U.S. Cl. CPC H04B 7/0617; H04B 7/0621; H04W 72/046; H04W 72/048; H04L 43/16

(57) ABSTRACT

Methods, systems, and devices for wireless communication are described, including: generating, by a first device having at least a first antenna, a first transmission radiation profile for the first antenna; receiving, by the first device, feedback from a second device that is indicative of a position and an orientation of the second device relative to the first device, the position and the orientation described by one or more Euler angles; comparing, by the first device, the feedback received from the second device to a predetermined threshold for a trigger that alters a beamwidth of the first antenna; and generating, by the first device, a second transmission radiation profile for a second antenna of the first device based at least in part on the feedback satisfying the predetermined threshold.

### BACKGROUND

The present disclosure, for example, relates to wireless communication systems, and more particularly to methods and systems related to triggering beamforming between devices used in virtual reality scenarios.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., IEEE 802.11) network may include access points (APs) that may communicate with one or more stations (STAs) or mobile devices. The AP may be coupled to a network, such as the Internet, and may enable a wireless device, such as a mobile device or virtual reality headset, to communicate via the network (or communicate with other devices coupled to the access point). A wireless device may communicate with a network device bi-directionally. For example, in a WLAN, a STA may communicate with an associated AP via a downlink (DL) and uplink (UL). The DL (or forward link) may refer to the communication link from the AP to the station, and the UL (or reverse link) may refer to the communication link from the station to the AP.

A device may share content and data with other devices, such as mobile devices, televisions, computers, audio systems, virtual reality headsets, heads-up displays, tablets, video panels, and the like. One device (i.e., a “source” device) may stream content and/or send data to another device (i.e., a “sink” device). In some applications, particularly in virtual reality scenarios, the sink device may be a virtual reality headset wired to the source device, which may be a computer system. The wired connection between the source device and the sink device may be cumbersome, and thus wireless connections may be utilized to enable freedom of movement for the user. However, as the user moves his head, the wireless connection between the source device and the sink devices may suffer, as devices' respective antennas fall out of alignment with one another.

In addition to being cumbersome, previous connections between the source device and the sink device may operate where the sink device does a majority of the processing. In such cases, the sink device may not have sufficient antenna space (due to the limited size of a headset). Thus, the availability of a plurality of antenna patterns is limited. Furthermore, the amount of processing at the headset may create an issue with regard to heat dissipation. Because the headset is worn by a user, controlling the amount of heat produced by processing is important.

### SUMMARY

The described features generally relate to one or more improved systems, methods, and/or apparatuses for triggering beamforming by a transmitting antenna. In some embodiments, a receiving antenna may trigger beamforming. The source device (e.g., the transmitting device) may receive data from the sink device (e.g., the receiving device) related to a change of a user's head position, and if the received data satisfies a predetermined threshold, the source device may trigger beamforming on a transmitting antenna. The sink device may be herein referred to as a “virtual reality headset” or a “head-mounted device.”

A method for wireless communication is described. The method may include: generating, by a first device having at least a first antenna, a first transmission radiation profile for the first antenna; receiving, by the first device, feedback from a second device that is indicative of a position and an orientation of the second device relative to the first device, the position and the orientation described by one or more Euler angles; comparing, by the first device, the feedback received from the second device to a predetermined threshold for a trigger event that initiates beamforming by at least one antenna element of a second antenna of the first device; and generating, by the first device, a second transmission radiation profile for the second antenna of the first device based at least in part on the feedback satisfying the predetermined threshold.

A first device for wireless communication is described. The first device may include a processor; memory in electronic communication with the processor; and instructions stored in the memory and operable, when executed by the processor, to cause the processor to: generate, by the first device having at least a first antenna, a first transmission radiation profile for the first antenna; receive, by the first device, feedback from a second device that is indicative of a position and an orientation of the second device relative to the first device, the position and the orientation described by one or more Euler angles; compare, by the first device, the feedback received from the second device to a predetermined threshold for a trigger event that initiates beamforming by at least one antenna element of a second antenna of the first device; and generate, by the first device, a second transmission radiation profile for the second antenna of the first device based at least in part on the feedback satisfying the predetermined threshold.

A communications device is described. The communications device including: means for generating, by the communications device having at least a first antenna, a first transmission radiation profile for the first antenna; means for receiving, by the communications device, feedback from a second device that is indicative of a position and an orientation of the second device relative to the first device, the position and the orientation described by one or more Euler angles; means for comparing, by the communications device, the feedback received from the second device to a predetermined threshold for a trigger event that initiates beamforming by at least one antenna element of a second antenna of the first device; and means for generating, by the communications device, a second transmission radiation profile for the second antenna of the first device based at least in part on the feedback satisfying the predetermined threshold.

A non-transitory computer-readable medium storing code for wireless communication is described. The code may comprise instructions executable to: generate, by a first device having at least a first antenna, a first transmission radiation profile for the first antenna; receive, by the first device, feedback from a second device that is indicative of a position and an orientation of the second device relative to the first device, the position and the orientation described by one or more Euler angles; compare, by the first device, the feedback received from the second device to a predetermined threshold for a trigger event that initiates beamforming by at least one antenna element of a second antenna of the first device; and generate, by the first device, a second transmission radiation profile for the second antenna of the first device based at least in part on the feedback satisfying the predetermined threshold.

Some examples of the method, first device, communications device, or non-transitory computer-readable medium described above may further include processes, features, means, or instructions where initiating beamforming includes selecting the at least one antenna element based at least in part on values extracted from a transmission profile table. Some examples of the method, first device, communications device, or non-transitory computer-readable medium described above may further include processes, features, means, or instructions where generating the second transmission radiation profile includes altering a beamwidth of the second antenna of the first device in a second direction according to the second transmission radiation profile, the second direction being different from the first direction.

Some examples of the method, first device, communications device, or non-transitory computer-readable medium described above may further include processes, features, means, or instructions where initiating beamforming includes selecting the at least one antenna element based at least in part on values extracted from a transmission profile table.

In some examples of the method, apparatus, or non-transitory computer-readable medium described above, generating the first transmission radiation profile includes altering the beamwidth of the first antenna of the first device in a first direction according to the first transmission radiation profile.

In some examples of the method, apparatus, or non-transitory computer-readable medium described above, generating includes altering a beamwidth of the second antenna of the first device in a second direction according to the second transmission radiation profile, the second direction being different from the first direction.

In some examples of the method, apparatus, or non-transitory computer-readable medium described above, the predetermined threshold is further indicative of a distance from a focal point of the first antenna associated with the first transmission radiation profile.

Some examples of the method, first device, communications device, or non-transitory computer-readable medium described above may further include generating a transmission profile table that relates the feedback from the second device to one or more transmission radiation profile values.

In some examples of the method, apparatus, or non-transitory computer-readable medium described above, generating the transmission profile table includes implementing a training procedure to update the transmission profile table, the training procedure configured to satisfy a predetermined signal strength threshold associated with a signal strength of the first transmission radiation profile received by the second device when the second device is at a plurality of predetermined locations and in a plurality of predetermined orientations.

In some examples of the method, apparatus, or non-transitory computer-readable medium described above, generating the second transmission radiation profile includes comparing the feedback to the transmission profile table; and generating the second transmission radiation profile based at least in part on the transmission radiation profile value related to the feedback in the transmission profile table.

In some examples of the method, apparatus, or non-transitory computer-readable medium described above, generating includes generating the first transmission radiation profile having a first focal point and a first cross-section distributed around the first focal point.

In some examples of the method, apparatus, or non-transitory computer-readable medium described above, generating includes generating the second transmission radiation profile includes generating the second transmission radiation profile having a second focal point and the first cross-section distributed around the second focal point, the second focal point being different from the first focal point.

In some examples of the method, apparatus, or non-transitory computer-readable medium described above, generating includes generating the second transmission radiation profile includes generating the second transmission radiation profile having the first focal point and a second cross-section distributed around the first focal point, the second cross-section being different from the first cross-section.

In some examples of the method, apparatus, or non-transitory computer-readable medium described above, generating includes generating the second transmission radiation profile includes generating the second transmission radiation profile having a second focal point and a second cross-section distributed around the second focal point, the second focal point being different from the first focal point, and the second cross-section being different from the first cross-section.

In some examples of the method, apparatus, or non-transitory computer-readable medium described above, comparing the feedback further includes comparing feedback indicative of the position and the orientation of the second device relative to a perimeter of the first cross-section of the first transmission radiation profile, wherein the perimeter is related to the predetermined threshold.

In some examples, the feedback comprises position and orientation data indicative of the position and the orientation of the second device and signal strength data indicative of a signal strength of the first transmission radiation profile detected by the second device.

In some examples of the method, apparatus, or non-transitory computer-readable medium described above, comparing the feedback further includes comparing: (i) the position and orientation data to the predetermined threshold and (ii) the signal strength data to a predetermined signal strength threshold.

In some examples of the method, apparatus, or non-transitory computer-readable medium described above, generating the second transmission radiation profile includes generating the second transmission radiation profile based at least in part on the position and orientation data satisfying the predetermined threshold and the signal strength data satisfying the predetermined signal strength threshold.

In some examples of the method, apparatus, or non-transitory computer-readable medium described above, generating the second transmission radiation profile includes increasing a transmission power of the first transmission radiation profile based at least in part on determining that the signal strength data satisfies the predetermined signal strength threshold and that the Euler angles associated with the position and orientation data are less than the predetermined threshold, the second transmission radiation profile being the same as the first transmission radiation profile.

In some examples of the method, apparatus, or non-transitory computer-readable medium described above, generating the second transmission radiation profile includes generating the second transmission radiation profile receiving feedback includes receiving the feedback from the second device intermittently at periodic time intervals.

In some examples, the feedback is indicative of Euler angles of the second device relative to the first device. In some examples: (i) the first device is a source computing device configured to generate data indicative of a virtual reality presentation, and (ii) the second device is a head-mounted device having a display configured to output at least a portion of the virtual reality presentation to a user of the second device.

In some examples, the feedback (i) is generated by one or more sensors coupled to the second device and (ii) is indicative of a position and an orientation of a head of the user of the second device. In some examples, the feedback is indicative of a position and an orientation of at least one antenna of the second device relative to a position and an orientation of the at least the first antenna or the second antenna of the first device.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system in accordance with aspects of the present disclosure;

FIG. 2 illustrates an example of an antenna radiation pattern in a wireless communication system in accordance with aspects of the present disclosure;

FIG. 3 illustrates a Euler coordinate system in a three-dimensional space in accordance with aspects of the present disclosure;

FIG. 4 illustrates an example of a process flow of a wireless communication in accordance with aspects of the present disclosure;

FIG. 5 illustrates an example antenna profile table in accordance with aspects of the present disclosure;

FIG. 6 illustrates a block diagram of a wireless communication system in accordance with aspects of the present disclosure;

FIG. 7 illustrates a block diagram of a wireless communication system in accordance with aspects of the present disclosure;

FIG. 8 illustrates a block diagram of an example apparatus in a wireless communication system in accordance with aspects of the present disclosure; and

FIGS. 9-11 illustrate methods related to a wireless communication system in accordance with aspects of the present disclosure.

### DETAILED DESCRIPTION

In a virtual reality environment, a user may wear a head-mounted computing device (e.g., a headset), in which the user experiences audio and/or video data output while wearing a head-mounted device (HMD). In some embodiments, the HMD may be a “sink” device which receives signals and data from a “source” device, such as a computer or smartphone. In order for the HMD to provide a robust user experience, the HMD receives data as consistently and with as high of quality as possible. Because the output devices (e.g., video screen, speakers) are in such close proximity to the user's ears and eyes, any errors in rendering or producing sound will be readily noticed by at least the user of the HMD. In addition, in a virtual reality environment, the system may re-render a new image based on feedback received from the user (e.g., voice commands, movement of the head, arms, hands, or legs, and/or other user input). The amount of information and bandwidth needed to provide the information from the source device to the HMD may be large; thus, techniques are discussed below to provide and maintain a high bandwidth wireless connection between the HMD and a source device by triggering beamforming of at least one antenna based at least in part on the position and orientation of the HMD while being worn by a user.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

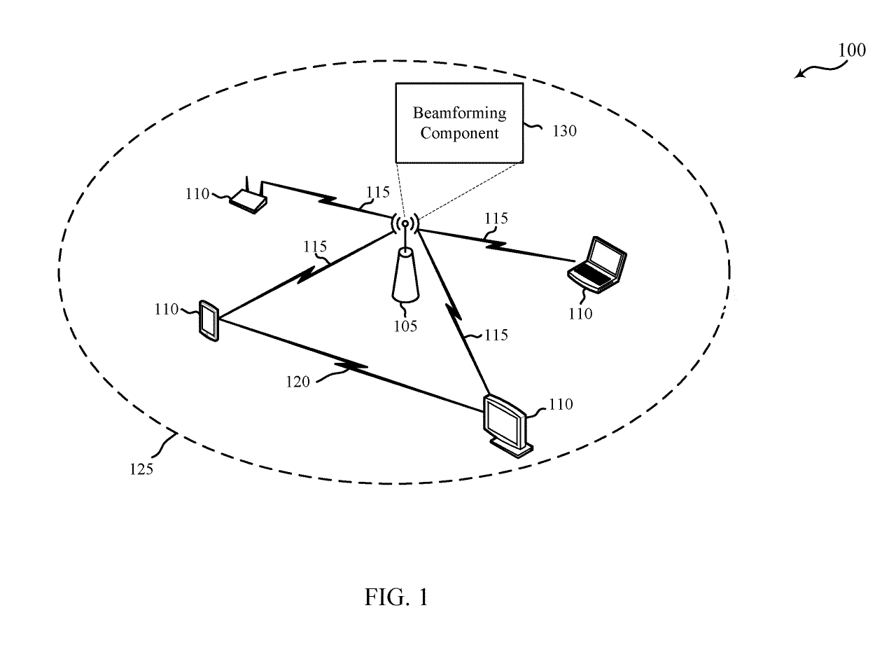

Referring first to FIG. 1, a block diagram illustrates an example of a wireless local area network (WLAN) network 100 such as, e.g., a network implementing at least one of the IEEE 802.11 family of standards, including the 802.11ah standards. The WLAN network 100 may include an access point (AP) 105 and one or more wireless devices or stations (STAs) 110, such as mobile stations, personal digital assistants (PDAs), other handheld devices, netbooks, notebook computers, tablet computers, laptops, display devices (e.g., TVs, computer monitors), printers, etc. While only one AP 105 is illustrated, the WLAN network 100 may have multiple APs 105. Each of the STAs 110, which may also be referred to as mobile stations (MSs), mobile devices, access terminals (ATs), user equipment (UE), subscriber stations (SSs), or subscriber units, may associate and communicate with an AP 105 via a communication link 115. Each AP 105 has a geographic coverage area 125 such that STAs 110 within that area can typically communicate with the AP 105. The STAs 110 may be dispersed throughout the geographic coverage area 125. Each STA 110 may be stationary or mobile. One or more of the STAs 110 and/or APs 105 may comprise a beamforming adjustment component 130, which may enable the STAs 110 and/or the APs 105 to trigger adjustments to beamforming associated with wireless communications between a plurality of STAs 110 and/or between the STAs 110 and the APs 105.

WLAN network 100 may support directional transmissions between the STAs 110 and/or between the APs 105 and the STAs 110. For example, AP 105 and/or STAs 110 may be configured with more than one antenna (e.g., an antenna array), where selection of particular antennas, antenna gain, etc., operate to transmit signals in a directional or beamformed manner. The beamform width and/or the direction of the directional transmission may be controlled by the AP 105 and/or any of the STAs 110. In some aspects, an AP 105 may determine the location of STAs within the coverage area 125 based on feedback information received from the STAs 110. In other aspects, a STA 110 may determine the location of another STA 110 based on feedback information received from the other STA 110.

Although not shown in FIG. 1, a STA 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A geographic coverage area 125 for an AP 105 may be divided into sectors making up only a portion of the coverage area (not shown). The WLAN network 100 may include APs 105 of different types (e.g., metropolitan area, home network, etc.), with varying sizes of coverage areas and overlapping coverage areas for different technologies. Although not shown, other wireless devices can communicate with the AP 105.

While the STAs 110 may communicate with each other through the AP 105 using communication links 115, each STA 110 may also communicate directly with one or more other STAs 110 via a direct wireless link 120. Two or more wireless STAs 110 may communicate via a direct wireless link 120 when both STAs 110 are in the AP geographic coverage area 125 or when one or neither STA 110 is within the AP geographic coverage area 125 (not shown). Examples of direct wireless links 120 may include Wi-Fi Direct connections, connections established by using a Wi-Fi Tunneled Direct Link Setup (TDLS) link, and other peer-to-peer (P2P) group connections. The STAs 110 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other P2P connections and/or ad hoc networks may be implemented within WLAN network 100.

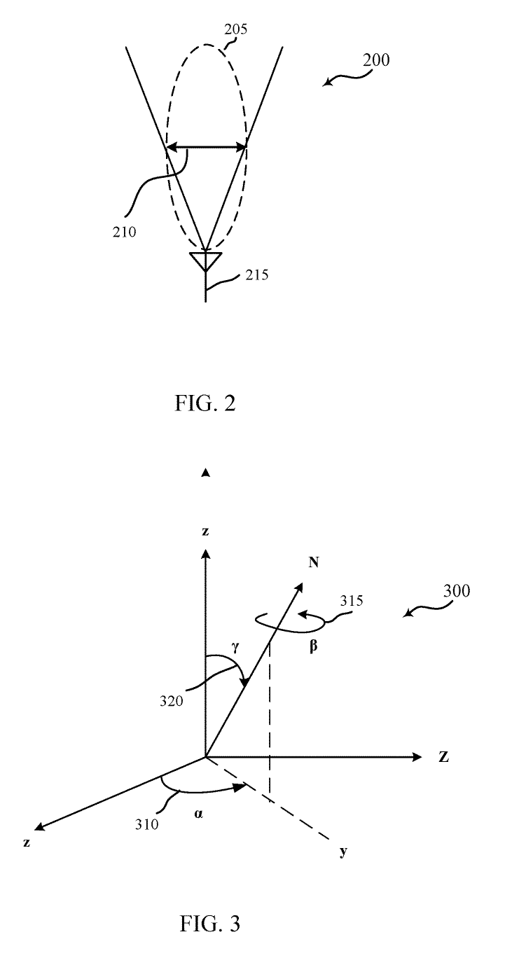

FIG. 2 illustrates an example of an antenna radiation pattern 200 in a wireless communication system in accordance with aspects of the present disclosure. Antenna 215 may be included on an AP, such as an AP 105 as described with reference to FIG. 1. In other examples antenna 215 may be included as part of an antenna array in one of a plurality of STAs, such as the STAs 110 described with reference to FIG. 1. In one embodiment, antenna 215 produces a radiation pattern or a directional dependence of a strength of radio waves emitted from the antenna. A main lobe 205 is shown by the dotted oval line, where the main lobe may be the main antenna beam indicative of the lobe containing the greatest field strength of the antenna. The beamwidth 210 of the radiation pattern may be the measurement of the cross-section of a power transmission profile or the width of the main lobe 205.

In a phased array system, the respective signals feeding an array of antenna are set such that the effective radiation pattern of the array is reinforced in a desired direction and suppressed in an undesired direction. The antenna array may include antenna elements and produce a plurality of sector-shaped radiation patterns. In some cases, an array of antenna elements used for beamforming may increase antenna gain in the direction of the signal while decreasing the gain in other directions (e.g., increasing a signal-to-noise (SNR) ratio by amplifying the signal coherently.

The antenna radiation pattern 200, and thus the beamwidth 210, may be changed by beamforming techniques. Beamforming may be a signal processing technique which enables directional signal transmission or reception in a sensor array, such an array of antenna elements. The directionality of the array may be changed by controlling the phase and relative amplitude of the signal at the transmitter. The phase and relative amplitude may be referred to as “antenna weight vectors” (AWV). Beamforming may be used at both a transmitter (Tx beamforming) and/or a receiver (Rx beamforming).

FIG. 3 illustrates a Euler coordinate system 300 in a three-dimensional space in accordance with aspects of the present disclosure. The Euler coordinate system 300 may be defined by three-Euler angles: α 310, β 315, and γ 320, where α, β, and γ describe the position and orientation of a rigid body in the three-dimensional space. In one embodiment, a change of the Euler angles may represent the change of position and orientation of a HMD as a user moves his or her head.

More specifically, the Euler angles represent a sequence of elemental rotations, or rotations around the axes of the coordinate system: angle α 310 may represent a rotation around the z-axis, angle β 315 may represent a rotation around the N-axis, and angle γ 320 may represent a rotation around the Z-axis. In some embodiments, the angles α, β, and γ may be referred to as “yaw,” “pitch,” and “roll,” and/or “azimuth,” “elevation,” and “roll.”

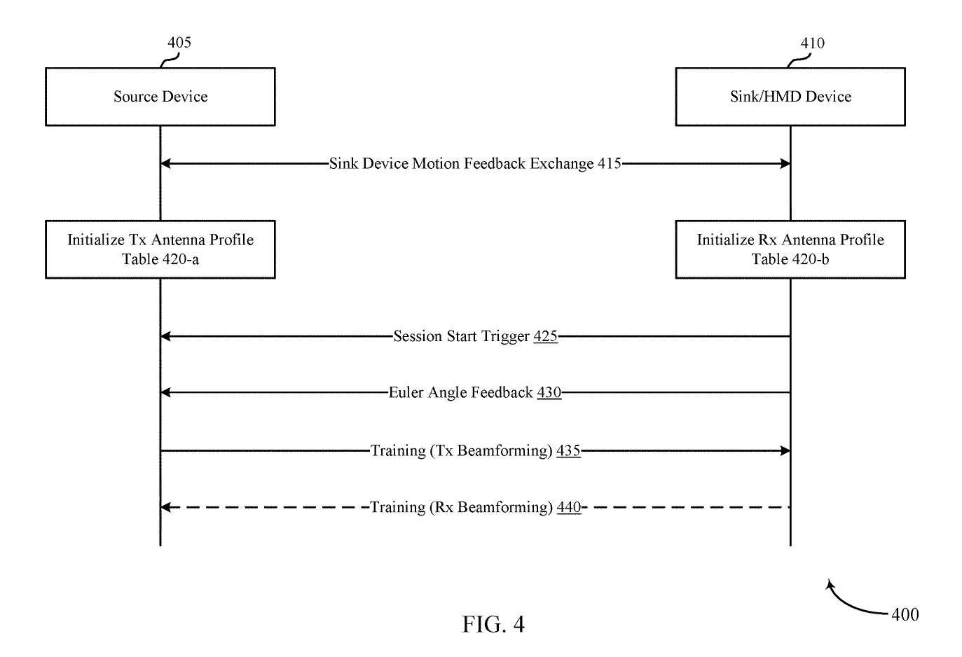

FIG. 4 illustrates an example of a process flow 400 of a wireless communication in accordance with aspects of the present disclosure. In one example, a virtual reality environment includes a source device 405 and a sink device 410 in wireless communication with one another. In one embodiment, the sink device 410 may be a head-mounted device (HMD) which is worn by a user in the virtual reality environment, whereas the source device 405 may be a device such as a desktop computer, server, laptop computer, smartphone, tablet, etc. While wearing the HMD, the user may tilt, rotate, and turn his head in order to interact with the content provided by the source device 405 to the user on the HMD 410.

In some examples, the content sent from the source device 405 to the HMD 410 may be high bandwidth content (e.g., 60 GHz). In addition, the display provided to the user within the HMD is close to the user's eyes (e.g., within 12 inches), and thus any artifacts (e.g. anomalies in the graphical representation) would be easily discernable. In other examples, movement by the user or other user input results in a need to provide a fast re-rendering of the graphics provided to the user at the HMD 410. With frequent and expected movement of the HMD 410, however, the antennas of the source device 405 and HMD 410 may fall out of alignment, thus resulting in a degradation of content transmission.

In order to keep the antennas of the source device 405 and the HMD 410 in as close alignment as frequently as possible, the antennas of each device may be trained to perform beamforming when it is determined that the antennas have fallen out of alignment. FIG. 4 shows an example sequence of steps and communications between the source device 405 and the HMD 410 which enable beamforming. The first example step in the sequence may be indicative of a sink device motion feedback exchange as show at step 415. At step 415, data related to the head movement of the user wearing the HMD 410 is transmitted to the source device 405. In some examples, the data may be referred to as “motion feedback” or “feedback.”

At step 415, an exchange of data indicative of a change in Euler angles (α, β, and γ) may occur, as the user moves his head relative to the source device 405. In another embodiment, the exchange of motion feedback of the HMD 410 may be recorded as beamforming training information and may be stored in a plurality of antenna profile tables. In one example, both the source device 405 and the HMD 410 may maintain a separate and independent antenna profile tables (e.g., the source device 405 may maintain its own Tx antenna profile table and its own Rx antenna profile table, whereas the HMD 410 may similarly maintain its own Tx antenna profile table and its own Rx antenna profile table). The source device 405 and the HMD 410 may not necessarily share antenna profile tables; however, in other embodiments, it is possible for the source device 405 and the HMD 410 to share antenna profile tables.

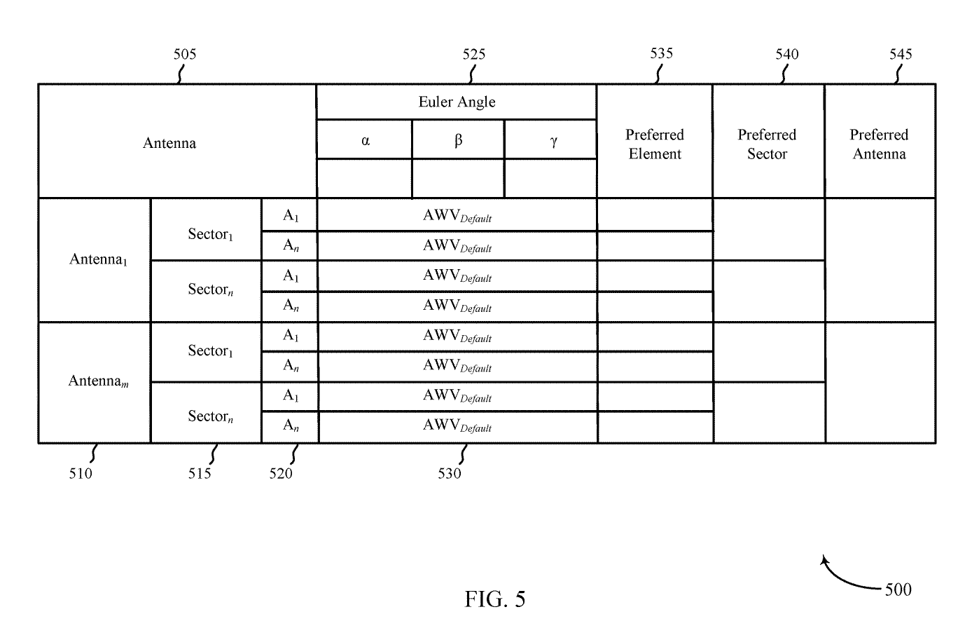

At steps 420-a and 420-b, the source device 405 and the HMD 410 initialize respective antenna profile tables. In this example, the source device 405 initializes a Tx antenna profile table, and the sink device initializes a Rx antenna profile table. Each antenna profile table may be initialized with a plurality of values including antenna vector data, antenna element data, default antenna weight vectors, initial Euler-angle positions of the devices, and the like. Specifics related to the antenna profile table will be described in more detail with reference to FIG. 5.

After the antenna profiles are initialized, the HMD 410 may initiate a “session start trigger.” The trigger may be indicative of a decision to beamform at least one antenna. Because beamforming consumes power, triggering beamforming may occur at times when the source device and the sink device are exchanging information which will make a difference in the communication of content. If at least one of the Euler angles associated with the HMD 410 changes more than a predetermined threshold θ, the antennas may have fallen out of alignment or are likely to fall out of alignment, and thus beamforming may be triggered at the transmitting device (i.e., the source device 405) in order to align antennas with the moving receiving device (e.g., the HMD 410).

At step 430, the HMD 410 provides Euler angle feedback data to the source device 405. With reference to example head movement, Euler angle feedback data may refer to the change in the movement of the head. As the user moves his head, and thus the HMD 410 moves, motion feedback data of the change of Euler angles related to head movement is transmitted to the source device 405. The movement in which the head is rotating side-to-side (such that the user is looking left and right) may be referred to as a change in α, yaw, and/or azimuth. An example range of the change in α, yaw, and/or azimuth may be −80° to 80° around the z-axis. The movement in which the head is looking up and down may be referred to as a change in β, pitch, and/or elevation. An example range of the change in β, pitch, and/or elevation may be −60° to 60° around the N-axis. The movement in which the head is tilting side to side (while still looking forward), may be referred to as a change in γ and/or roll. An example range of the change in γ and/or roll may be −30° to 30° around the Z-axis.

In some embodiments, the HMD 410 may send Euler angle feedback data to the source device 405 when the HMD 410 moves. In other embodiments, Euler angle feedback data may be sent when a change in at least one of the Euler angles satisfies a predetermined threshold (where the change in movement results in a change of angle relative to a focal point, where the change in angle satisfies a threshold).

Once the source device 405 receives Euler angle feedback data from the HMD 410, one or both of the devices may determine that a change in at least one of the Euler angles triggers beamforming. In one embodiment, in order to process the feedback in an efficient manner, the source device 405 may do at least a majority of the data processing. The HMD 410 is likely to be smaller in size than the source device, due to its wearable nature. As a result, in one embodiment, the source device 405 will have more space for antennas, and thus will be able to select from a larger group of antenna patterns. In addition, the HMD 410 is worn close to a user's body and skin, and thus heat dissipation is a consideration. By directing at least a majority of the processing to the source device 405, the concern about heat due to processing at the HMD 410 may be reduced.

Returning to FIG. 2, the energy provided by the antenna 215 is constrained within the main lobe 305 (side lobes are not shown in FIG. 2). If at least one of the Euler angles of the HMD 410 changes such that the receiving antenna falls outside of the cross-section of the main lobe 205, then the transmitting antenna and the receiving antenna has fallen out of alignment and beamforming may be triggered. The threshold angle θ may be based at least in part on the measured beamwidth, half of a beamwidth, a quarter of a beamwidth, etc. In one example, if the trigger is set to a “passive” setting, the threshold angle θ may be related to the beamwidth 210. In another example, if the trigger is set to a “sensitive” setting, the threshold angle θ may be related to one-half the beamwidth 210.

Beamforming at the transmitting device (Tx beamforming 435) may be performed; however, beamforming may also be optionally effected at the receiving device (Rx beamforming 440). In some embodiments, beamforming may improve transmission and/or reception gains and may reduce interferences with neighboring transmissions. In other embodiments, beamforming at the transmitter (Tx beamforming) may improve the physical layer (PHY) rate of the transmitter, thus improving quality of service (QoS) and reducing the time for data transmission.

As Euler angle feedback data is received by the source device 405 from the HMD 410, the antenna profile tables may be updated. Updating the antenna profile tables with varying antenna weight vectors may be referred to as “training” the antenna weight vectors. Training may result in efficient communications between the source device 405 antennas and the sink device 410 antennas. Training, however, may take time. Thus, at the beginning of step 435 (and/or optionally step 440), the antenna weight vectors (AWV) are initialized and synchronized to be the same values as one another. After the first beamforming is triggered, then the values of the AWV change to indicate a preferred antenna element, preferred sector, preferred antenna, preferred AWV, etc., for each combination of Euler angles α, β, and γ.

FIG. 5 illustrates an example antenna profile table 500 in accordance with aspects of the present disclosure. The antenna profile table 500 may be a record of beamforming training information for the WLAN 100, where the data recorded in the antenna profile table is based on the movement of the HMD in relation to the source device and the antennas at the source device and the sink device. Each device may maintain its own Tx antenna profile table and may also maintain its own Rx antenna profile table.

Each device may include one or more antennas 510. In one embodiment, at least one of the antennas may be a phased array antenna. Each phased array antenna may include multiple sectors 515 of antennas (e.g., 8 sectors per antenna), with each sector including multiple antenna elements 520 (e.g., 8 elements per sectors). Thus, for each, a single phased array antenna may include 64 antenna elements.

Antenna profile table 500 shows two example antennas, Antenna₁ and Antennaₘ, where m may be any number greater than 1. Each example antenna has two example sectors, Sector₁ and Sectorₙ, where n may be any number greater than 1. Further, each example sector, may have two example antenna elements, A₁ and Aₙ, where n may be any number greater than 1. Although two antennas, two sectors, and two antenna elements are shown by example, any number of antennas, sectors, and/or antenna elements may be contemplated.

Before Euler angle feedback data is received (and thus potentially before any beamforming), the antenna weight values (AWV) may be set to a default level based on the antennas 510, sectors 515 and/or antenna elements 510. Thus, AWV_{default} 530 values may be initialized and synchronized to one default value. The default value may be indicative of a default position and orientation of each or both of the source device and/or the HMD. Generally, the default values relate to the position and orientation of the HMD, as the HMD is likely to be the device which experiences movement. Initial transmissions between the source device and the HMD are thus transmitted using the AWV_{default} values.

Once the source device receives Euler angle feedback data from the HMD, the antenna profile table may be updated. In one embodiment antenna training symbols may be exchanged between the source device and the HMD. The antenna training symbols may be appended to the end of a data packet transmitted between the source device and the HMD. In another example, the antenna training symbols may be transmitted as special beamforming packets in the data transmission. When the device (or receiving device) receives the training symbols, statistics related to the antenna training symbols are reported to a transmitter. The statistics may include a Tx antenna identifier (ID), a Tx antenna element ID, a Tx sector ID, related SNR, etc.

Based on the training symbols and the Euler angle feedback data, an antenna profile table may update the preferred element 535, preferred sector 540, and preferred antenna 545 sections of the antenna profile table 500. Thus, further transmissions between the source device and the HMD may be sent based on updated data and based on the preferred element 535, preferred sector 40, and preferred antenna 545.

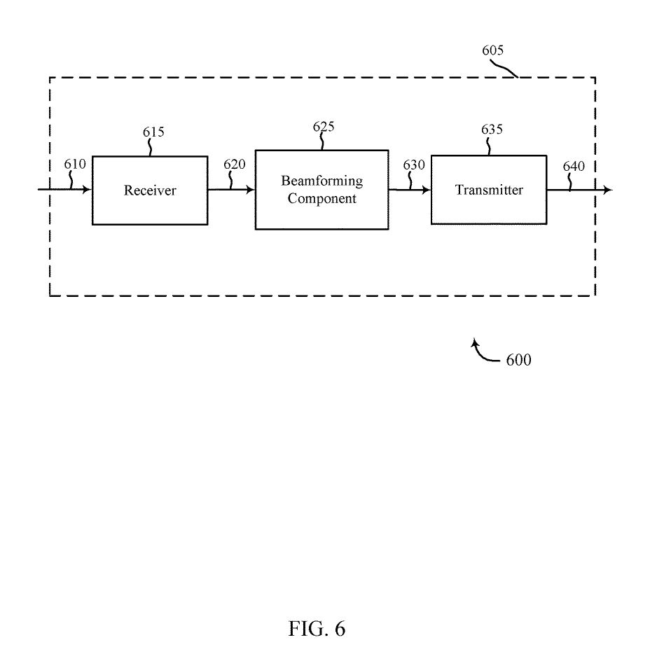

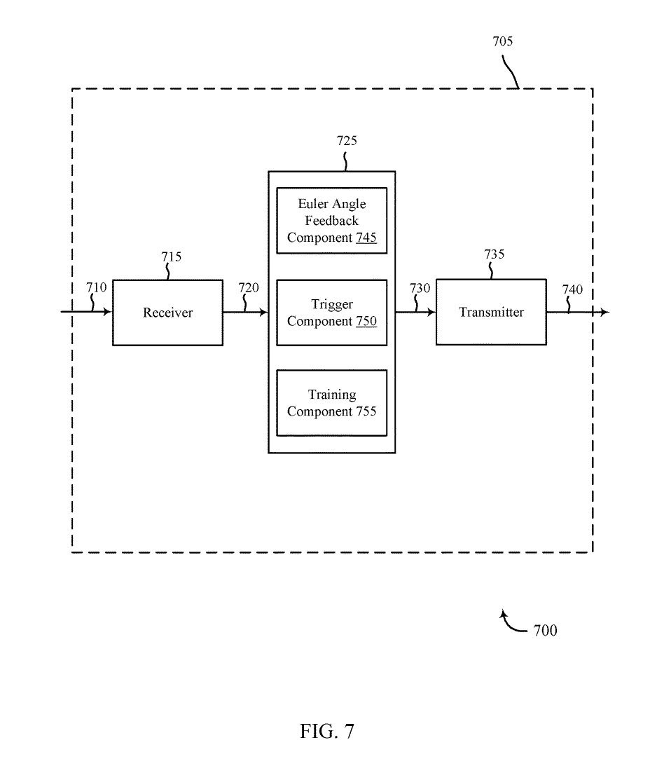

FIG. 6 illustrates a block diagram of a wireless device 605, which may be an example of aspects of a STA 110 or an AP 105 as described with reference to FIGS. 1 through 5. In addition, wireless device 605 may be an example of a source and/or sink device present in a virtual reality environment such as devices 405 and 210 described with reference to FIG. 2, respectively. Wireless device 605 may include receiver 615, beamforming component 625, and transmitter 635. Wireless device 605 may also include a processor. Each of these components may be in communication with each other (e.g., via signals 610, 620, 630, and 640).

The receiver 615 may include a circuit or circuitry for receiving information such as packets, user data, or control information associated with various information channels (e.g., control channels, data channels, and information related beamforming training and adjustment in virtual reality environments, etc.). Information may be passed on to other components of the device. The receiver 615 may be an example of aspects of the transceiver 825 described with reference to FIG. 8.

The beamforming component 625 may include a circuit or circuitry for triggering beamforming. In some embodiments, the beamforming component 625 may be part of a source device or a sink device (e.g., a HMD) and may receive or transmit data related to communications between the source and the sink device. For example, if device 605 is an example of a source device, beamforming component 625 may receive feedback data related to changes in the Euler angles of a sink device with which the source device is in communication. In addition, the beamforming device may establish predetermined thresholds which, when satisfied, trigger beamforming of at least one of a transmitting and/or a receiving antenna. In one example embodiment, the predetermined threshold may be threshold angle θ, where if one of the Euler angles α, β, γ measured at the sink devices varies by equal to or greater than threshold angle θ, beamforming may be triggered. For example, threshold angle θ may represent a change of angle of 3°, where if α, β, or γ varies by 3° or more, beamforming is triggered. In another example embodiment, threshold angle θ may be indicative not of the change in angle, but a discrete angle value which may be exceeded by the position and orientation of the sink device. For example, for Euler angle α (i.e., yaw and/or azimuth), the range of motion around the axis may be −80° to 80°. Movement of the HMD within the −80° to 80° range may not result a misalignment of the antennas; however, if the user moves his head more than 80° from the axis, the antennas may fall out of alignment and cause anomalies in the display. Thus, the predetermined threshold angle θ which triggers beamforming may be ±85°, where if feedback data for Euler angle α is determined to be more than ±85°, beamforming may be triggered.

In other embodiments, beamforming may be alternatively or additionally triggered due to a variation in measured or determined packet error rate (PER) and/or signal-to-noise ratio (SNR). A predetermined PER threshold may be established, such as 10%. If the measured PER is greater than the predetermined threshold, then beamforming is not triggered. If the measured PER is less than the predetermined threshold, then beamforming is triggered. A predetermined SNR threshold may be established, such as 6 dB. If the measured SNR is greater than the predetermined threshold, then beamforming is triggered. If the measured SNR is less than the predetermined threshold, then beamforming is not triggered.

The transmitter 635 may include a circuit or circuitry for transmitting signals received from other components of wireless device 605. In some examples, the transmitter 635 may be collocated with a receiver in a transceiver component. For example, the transmitter 635 may be an example of aspects of the transceiver 825 described with reference to FIG. 8. The transmitter 635 may include a single antenna, or it may include a plurality of antennas.

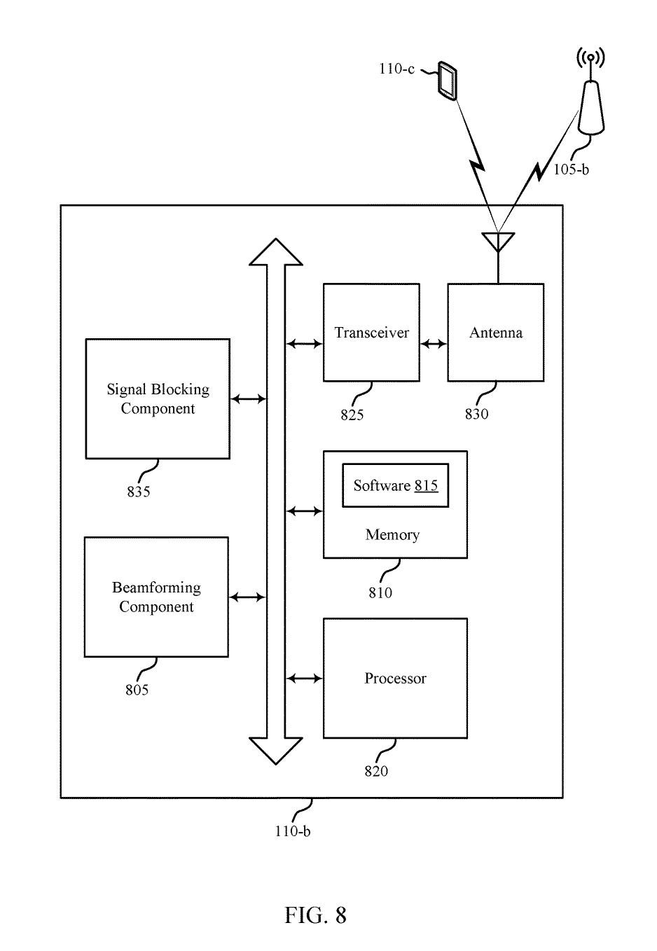

FIG. 7 illustrates a block diagram of a wireless device 705, which may be an example of aspects of a STA 110, an AP 105, wireless device 605 as described with reference to FIGS. 1 through 6. In addition, wireless device 705 may be an example of a source device and/or a sink device present in a virtual reality environment, such as devices 405 and 410 described with reference to FIG. 2, respectively. Wireless device 705 may include receiver 715, beamforming component 725, and transmitter 735. Wireless device 705 may also include a processor. The beamforming component 725 may include Euler angle feedback component 745, trigger component 750, and training component 755. Each of these components may communicate, directly or indirectly, with one another (e.g., via signals 710, 720, 730, and 740).

The receiver 715 may include a circuit or circuitry for receiving information which may be passed on to other components of the device 705. The receiver 715 may also perform the functions described with reference to the receiver 615 of FIG. 5. The receiver 715 may be an example of aspects of the transceiver 825 described with reference to FIG. 8.

The Euler angle feedback component 745 may include a circuit or circuitry for determining, calculating, sending and/or receiving data related to the position and orientation of a device. In some embodiments, a source device may receive feedback data related to the movement of a wireless connected sink device, such as the HMD. The Euler angle feedback component may receive Euler angle feedback data from sensors located on or around the HMD, such as a gyroscope, accelerometer, magnetometer, and/or a triangulation of location based on objects and/or sensors located in and around the HMD.

The Euler angle feedback data may be related to the position and orientation of the HMD in relation to the source device. In particular, Euler angle feedback component 745 may obtain and analyze data related to the movement of the HMD as angles representing rotations around the axes of a three-dimensional coordinate system, as described previously with reference to FIG. 3. Euler angle feedback data may be transmitted to the source device and/or may be stored in an antenna profile table at either or both a transmitter and/or a receiver.

The trigger component 750 may include a circuit or circuitry for triggering beamforming at one or more antennas. Beamforming may be triggered based at least in part on the Euler angle feedback data. Based on the change of Euler angles measured at the HMD compared against a predetermined threshold, beamforming may be triggered at a transmitting antenna. Beamforming is triggered to realign the directionality of the antennas in the source device and HMDs, respectively. In some embodiments, triggering beamforming may result in a faster and/or a strong signal in the WLAN network (e.g., a WiFi signal). In addition, the signal may have a longer range, and thus the source device and HMD may be placed farther away from one another. Furthermore, the PHY data rate may increase, thus improving the QoS and reduce the time for data transmission. The trigger component 750 may trigger Tx beamforming at a transmitter and/or trigger Rx beamforming at a receiver.

The training component 755 may include a circuit or circuitry for updating an antenna profile table with values to provide a preferred antenna element, preferred sector, and/or preferred antenna for beamforming. In one embodiment, antenna training symbols may be exchanged between the source device and the HMD. The antenna training symbols may be appended to the end of a data packet transmitted between the source device the HMD. In another example, the antenna training symbols may be transmitted as special beamforming packets in the data transmission. When the device (or receiving device) receives the training symbols, statistics related to the antenna training symbols are reported to a transmitter. The statistics may include a Tx antenna identifier (ID), a Tx antenna element ID, a Tx sector ID, related SNR, etc. Based on the training symbols and the Euler angle feedback data, an antenna profile table may update the preferred element, preferred sector and preferred antenna sections of the antenna profile table (as shown by example antenna profile table 500 in FIG. 5). The AWV may also be updated as part of the beamforming report statistics or may be refined through other beamforming data exchanges.

The transmitter 735 may include a circuit or circuitry for transmitting signals received from other components of wireless device 705. In some examples, the transmitter 735 may be collocated with a receiver in a transceiver component. For example, the transmitter 735 may be an example of aspects of the transceiver 825 described with reference to FIG. 8. The transmitter 735 may include a single antenna, or the transmitter 735 may include a plurality of antennas.

FIG. 8 illustrates a block diagram of an example apparatus in a wireless communication system in accordance with aspects of the present disclosure. For example, system 800 may include STA 110-b. In addition, STA 110-b may be in communication with STA 110-c. STAs 110-b and/or 110-c which may be examples of a source device 405, a sink device 410, a wireless device 600, a wireless device 700, or a STA 110 as described with reference to FIGS. 1 through 7. In another example, system 800 may represent a system including a wireless device such as an AP 105 as described herein.

STA 110-b may also include beamforming adjustment component 805, memory 810, processor 820, transceiver 825, antenna 830, and signal blocking component 835. Each of these components may communicate, directly or indirectly, with one another (e.g., via one or more buses). The beamforming adjustment component 805 may be an example of a beamforming adjustment component as described with reference to FIGS. 6 and 7.

The memory 810 may include random access memory (RAM) and read only memory (ROM). The memory 810 may store computer-readable, computer-executable software including instructions that, when executed, cause the processor to perform various functions described herein (e.g., triggering air-interface beamforming in virtual reality scenarios, etc.). In some cases, the software 815 may not be directly executable by the processor but may cause a computer (e.g., when compiled and executed) to perform functions described herein. The processor 820 may include an intelligent hardware device, (e.g., a central processing unit (CPU), a microcontroller, an application specific integrated circuit (ASIC), etc.)

The transceiver 825 may communicate bi-directionally, via one or more antennas, wired, or wireless links, with one or more networks, as described above. For example, the transceiver 825 may communicate bi-directionally with an AP 105-b, STA 110-b and/or STA 11o-c. The transceiver 825 may also include a modem to modulate the packets and provide the modulated packets to the antennas for transmission, and to demodulate packets received from the antennas. In some cases, the wireless device may include a single antenna 830. However, in some cases the device may have more than one antenna 830, which may be capable of concurrently transmitting or receiving multiple wireless transmissions.

Signal blocking component 835 may include a circuit or circuitry for triggering beamforming even if the changes in Euler angles of the sink device do not satisfy a threshold. In some embodiments, the signal between the source device and the sink device may degrade, without a change in Euler angles sufficient enough to trigger beamforming. For example, an object or person may pass between the sink and source devices, thus blocking the signal, resulting in reduced bandwidth and an increase in rendering artifacts on the sink device display. In this example embodiment, the source device may determine that the PER has increased over a predetermined PER threshold and/or the SNR has decreased below a predetermined SNR threshold. In either such case, beamforming may be triggered, regardless of the Euler angle feedback data.

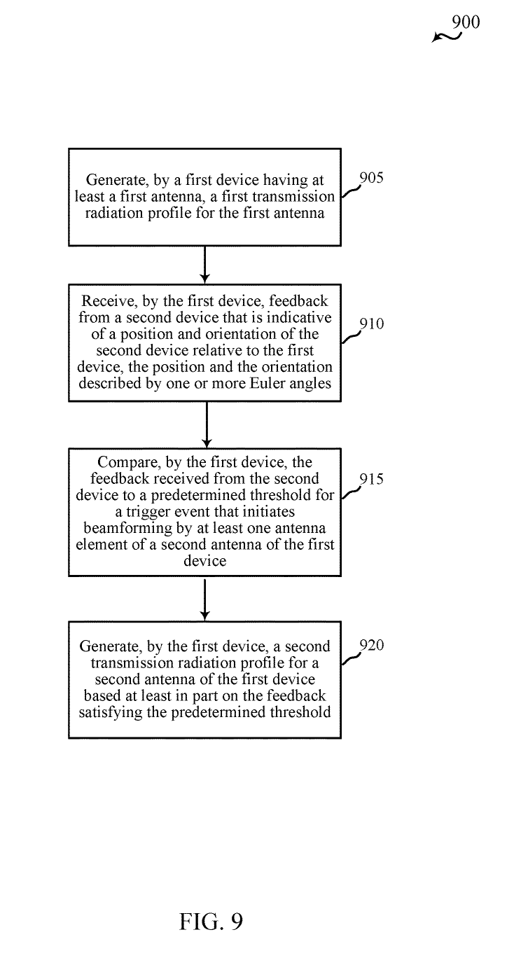

FIG. 9 illustrates a method related to a wireless communication system in accordance with aspects of the present disclosure. The operations of method 900 may be implemented by a device such as source device 405 and/or sink device 410 as described with reference to FIGS. 1 through 8. For example, the operations of method 900 may be performed by the beamforming component 625 as described herein. In some examples, the source device 405 and/or sink device 410 may execute a set of codes to control the functional elements of the device to perform the functions described below. Additionally or alternatively, the source device 405 and/or sink device 410 may perform aspects the functions described below using special-purpose hardware.

At block 905, the first device, having at least a first antenna, may generate a first transmission radiation profile for the first antennas as described above with reference to FIGS. 2 through 7. In certain examples, the operations of block 905 may be performed by one or more antennas associated with the first device, such as antenna 830 of FIG. 8

At block 910, the first device may receive feedback from a second device that is indicative of a position and orientation of the second device relative to the first device, the position and the orientation described by one or more Euler angles as described above with reference to FIGS. 2 through 7. In certain examples, the operations of block 910 may be performed by the Euler angle feedback component 745 as described with reference to FIG. 7.

At block 915, the first device may compare the feedback received from the second device to a predetermined threshold for a trigger event that initiates beamforming by at least one antenna element of a second antenna of the first device as described above with reference to FIGS. 2 through 7. In certain examples, the operations of block 920 may be performed by the trigger component 750 as described with reference to FIG. 7.

At block 920, the first device may generate a second transmission radiation profile for a second antenna of the first device based at least in part on the feedback satisfying the predetermined threshold as described above with reference to FIGS. 2 through 7. In certain examples, the operations of block 925 may be performed by the training component 755 as described with reference to FIG. 7.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for triggering beamforming between a source device and a sink device.

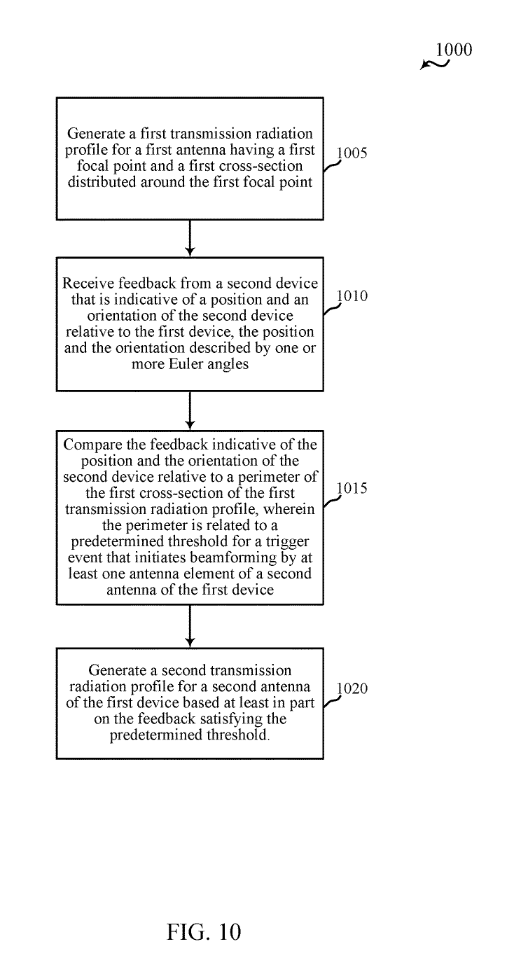

FIG. 10 illustrates a method related to a wireless communication system in accordance with aspects of the present disclosure. The operations of method 1000 may be implemented by a device such as source device 405 and/or sink device 410 as described with reference to FIGS. 1 through 8. For example, the operations of method 1000 may be performed by the beamforming component 625 as described herein. In some examples, the source device 405 and/or sink device 410 may execute a set of codes to control the functional elements of the device to perform the functions described below. Additionally or alternatively, the source device 405 and/or sink device 410 may perform aspects the functions described below using special-purpose hardware.

At block 1005, the first device, having at least a first antenna, may generate a first transmission radiation profile having a first focal point and a first cross-section distributed around the first focal point. In certain examples, the operations of block 1005 may be performed by one or more antennas associated with the first device, such as antenna 830 of FIG. 8.

At block 1010, the first device may receive feedback from a second device that is indicative of a position and orientation of the second device relative to the first device, the position and the orientation described by one or more Euler angles. In certain examples, the operations of block 1010 may be performed by the Euler angle feedback component 745 as described with reference to FIG. 7.

At block 1015, the first device may compare the feedback indicative of the position and the orientation of the second device relative to a perimeter of the first cross-section of the first transmission radiation profile, wherein the perimeter is related to the predetermined threshold for a trigger event that initiates beamforming by at least one antenna element of a second antenna of the first device. In certain examples, the operations of block 1015 may be performed by the Euler angle feedback component 745 as described with reference to FIG. 7.

At block 1020, the first device may generate a second transmission radiation profile for a second antenna of the first device based at least in part on the feedback satisfying the predetermined threshold. In certain examples, the operations of block 1020 may be performed by one or more antennas associated with the first device, such as antenna 830 of FIG. 8.

It should be noted that these methods describe possible implementation, and that the operations and the steps may be rearranged or otherwise modified such that other implementations are possible. In some examples, aspects from methods 900 and 1000 may be combined. For example, aspects of each of the methods may include steps or aspects of the other methods, or other steps or techniques described herein.

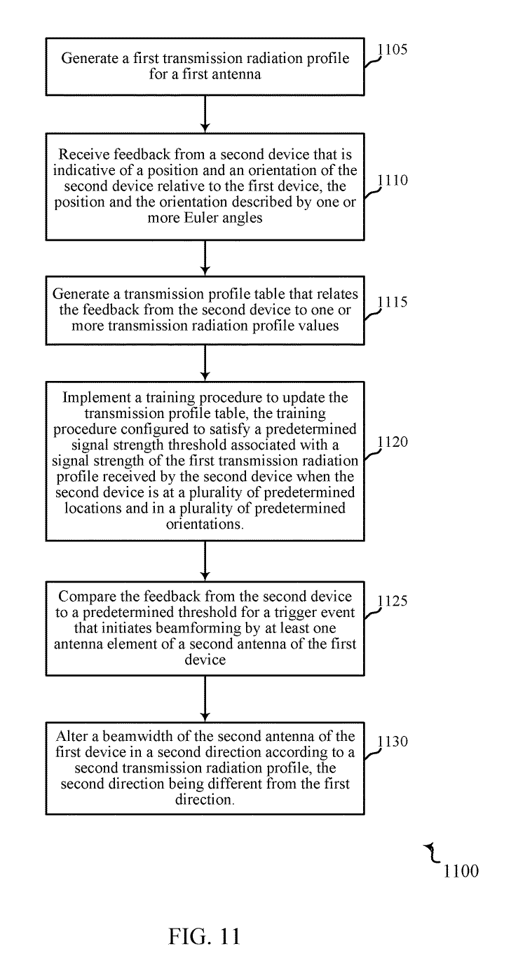

FIG. 11 illustrates a method related to a wireless communication system in accordance with aspects of the present disclosure. The operations of method 1000 may be implemented by a device such as source device 405 and/or sink device 410 as described with reference to FIGS. 1 through 8. For example, the operations of method 1000 may be performed by the beamforming component 625 as described herein. In some examples, the source device 405 and/or sink device 410 may execute a set of codes to control the functional elements of the device to perform the functions described below. Additionally or alternatively, the source device 405 and/or sink device 410 may perform aspects the functions described below using special-purpose hardware.

At block 1105, the first device, having at least a first antenna, may generate a first transmission radiation profile for a first antenna. In certain examples, the operations of block 1105 may be performed by one or more antennas associated with the first device, such as antenna 830 of FIG. 8.

At block 1110, the first device may receive feedback from a second device that is indicative of a position and an orientation of the second device relative to the first device, the position and the orientation described by one or more Euler angles. In certain examples, the operations of block 1110 may be performed by the Euler angle feedback component 745 as described with reference to FIG. 7.

At block 1115, the first device may generate a transmission profile table that relates the feedback from the second device to one or more transmission radiation profile values. In certain examples, the operations of block 1115 may be performed by the training component 755 as described with reference to FIG. 7.

At block 1120, the first device may implement a training procedure to update the transmission profile table, the training procedure configured to satisfy a predetermined signal strength threshold associated with a signal strength of the first transmission radiation profile received by the second device when the second device is at a plurality of predetermined locations and in a plurality of predetermined orientations. In certain examples, the operations of block 1120 may be performed by the training component 755 as described with reference to FIG. 7.

At block 1125, the first device may compare the feedback from the second device to a predetermined threshold for a trigger event that initiates beamforming by at least one antenna element of a second antenna of the first device. In certain examples, the operations of block 1115 may be performed by the Euler angle feedback component 745 as described with reference to FIG. 7.

At block 1130, the first device may alter a beamwidth of a second antenna of the first device in a second direction according to a second transmission radiation profile, the second direction being different from the first direction. In certain examples, the operations of block 1130 may be performed by one or more antennas associated with the first device, such as antenna 830 of FIG. 8.

It should be noted that these methods describe possible implementation, and that the operations and the steps may be rearranged or otherwise modified such that other implementations are possible. In some examples, aspects from methods 900, 1000, and/or 1100 may be combined. For example, aspects of each of the methods may include steps or aspects of the other methods, or other steps or techniques described herein. Thus, aspects of the disclosure may provide for beamforming in virtual reality environments.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be performed by one or more other processing units (or cores), on at least one IC. In various examples, different types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media may comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The wireless communications system or systems described herein may support synchronous or asynchronous operation. For synchronous operation, the APs and/or STAs may have similar frame timing, and transmissions from different APs and/or STAs may be approximately aligned in time. For asynchronous operation, the APs and/or STAs may have different frame timing, and transmissions from different APs and/or STAs may not be aligned in time. The techniques described herein may be used for either synchronous or asynchronous operations.

Thus, aspects of the disclosure may provide for modalities for triggering air-interface beamforming in virtual reality scenarios. It should be noted that these methods describe possible implementations, and that the operations and the steps may be rearranged or otherwise modified such that other implementations are possible. In some examples, aspects from two or more of the methods may be combined.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
generating, by a first device having at least a first antenna, a first transmission radiation profile for the first antenna;
receiving, by the first device, feedback from a second device that is indicative of a position and an orientation of the second device relative to the first device, the position and the orientation described by one or more Euler angles;
comparing, by the first device, the feedback received from the second device to a predetermined threshold for a trigger event that initiates beamforming by at least one antenna element of a second antenna of the first device; and
generating, by the first device, a second transmission radiation profile for the second antenna of the first device based at least in part on the feedback satisfying the predetermined threshold.

2. The method of claim 1, wherein initiating beamforming comprises selecting the at least one antenna element based at least in part on values extracted from a transmission profile table.

3. The method of claim 1, wherein generating the second transmission radiation profile comprises:
altering a beamwidth of the second antenna of the first device in a second direction according to the second transmission radiation profile, the second direction being different from the first direction.

4. The method of claim 1, wherein the predetermined threshold is further indicative of a distance from a focal point of the first antenna associated with the first transmission radiation profile.

5. The method of claim 1, further comprising:
generating a transmission profile table that relates the feedback from the second device to one or more transmission radiation profile values.

6. The method of claim 5, wherein generating the transmission profile table comprises:
implementing a training procedure to update the transmission profile table, the training procedure configured to satisfy a predetermined signal strength threshold associated with a signal strength of the first transmission radiation profile received by the second device when the second device is at a plurality of predetermined locations and in a plurality of predetermined orientations.

7. A first device for wireless communication, comprising:
a processor;
memory in electronic communication with the processor; and
instructions stored in the memory and operable, when executed by the processor, to cause the processor to:
generate, by the first device having at least a first antenna, a first transmission radiation profile for the first antenna;
receive, by the first device, feedback from a second device that is indicative of a position and an orientation of the second device relative to the first device, the position and the orientation described by one or more Euler angles;
compare, by the first device, the feedback received from the second device to a predetermined threshold for a trigger event that initiates beamforming by at least one antenna element of a second antenna of the first device; and
generate, by the first device, a second transmission radiation profile for the second antenna of the first device based at least in part on the feedback satisfying the predetermined threshold.

8. The first device of claim 7, wherein when the processor initiates beamforming, the instructions are further operable to select the at least one antenna element based at least in part on values extracted from a transmission profile table.

9. The first device of claim 7, wherein when the processor generates the first transmission radiation profile, the instructions are further operable to cause the processor to:
alter the beamwidth of the first antenna of the first device in a first direction according to the first transmission radiation profile.

10. The first device of claim 7, wherein when the processor generates the second transmission radiation profile, the instructions are further operable to cause the processor to:
alter a beamwidth of the second antenna of the first device in a second direction according to the second transmission radiation profile, the second direction being different from the first direction.

11. The first device of claim 7, wherein the predetermined threshold is further indicative of a distance from a focal point of the first antenna associated with the first transmission radiation profile.

12. The first device of claim 7, wherein the instructions are further operable to cause the processor to:
generate a transmission profile table that relates the feedback from the second device to one or more transmission radiation profile values.

13. The first device of claim 12, wherein when the processor generates the transmission profile table, the instructions are further operable to cause the processor to:
implement a training procedure to update the transmission profile table, the training procedure configured to satisfy a predetermined signal strength threshold associated with a signal strength of the first transmission radiation profile received by the second device when the second device is at a plurality of predetermined locations and in a plurality of predetermined orientations.

14. The first device of claim 7, wherein when the processor generates the second transmission radiation profile, the instructions are further operable to cause the processor to:
compare the feedback to the transmission profile table; and
generate the second transmission radiation profile based at least in part on the transmission radiation profile value related to the feedback in the transmission profile table.

15. The first device of claim 7, wherein when the processor generates the first transmission radiation profile, the instructions are further operable to cause the processor to:
generate the first transmission radiation profile having a first focal point and a first cross-section distributed around the first focal point.

16. The first device of claim 15, wherein when the processor generates the second transmission radiation profile, the instructions are further operable to cause the processor to:
generate the second transmission radiation profile having a second focal point and the first cross-section distributed around the second focal point, the second focal point being different from the first focal point.

17. The first device of claim 15, wherein when the processor generates the second transmission radiation profile, the instructions are further operable to cause the processor to:
generate the second transmission radiation profile having the first focal point and a second cross-section distributed around the first focal point, the second cross-section being different from the first cross-section.

18. The first device of claim 15, wherein when the processor generates the second transmission radiation profile, the instructions are further operable to cause the processor to:
generate the second transmission radiation profile having a second focal point and a second cross-section distributed around the second focal point, the second focal point being different from the first focal point, and the second cross-section being different from the first cross-section.

19. The first device of claim 15, wherein when the processor compares the feedback, the instructions are further operable to cause the processor to:
compare the feedback indicative of the position and the orientation of the second device relative to a perimeter of the first cross-section of the first transmission radiation profile, wherein the perimeter is related to the predetermined threshold.

20. The first device of claim 7, wherein the feedback comprises position and orientation data indicative of the position and the orientation of the second device and signal strength data indicative of a signal strength of the first transmission radiation profile detected by the second device; and
wherein when the processor compares the feedback, the instructions are further operable to cause the processor to compare: (i) the position and orientation data to the predetermined threshold and (ii) the signal strength data to a predetermined signal strength threshold.

21. The first device of claim 20, wherein when the processor generates the second transmission radiation profile, the instructions are further operable to cause the processor to:
generate the second transmission radiation profile based at least in part on the position and orientation data satisfying the predetermined threshold and the signal strength data satisfying the predetermined signal strength threshold.

22. The first device of claim 20, wherein when the processor generates the second transmission radiation profile, the instructions are further operable to cause the processor to:
increase a transmission power of the first transmission radiation profile based at least in part on determining that the signal strength data satisfies the predetermined signal strength threshold and that the Euler angles associated with the position and orientation data are less than the predetermined threshold, the second transmission radiation profile being the same as the first transmission radiation profile.

23. The first device of claim 7, wherein when the processor receives feedback, the instructions are further operable to cause the processor to:
receive the feedback from the second device intermittently at periodic time intervals.

24. The first device of claim 7, wherein the feedback is indicative of Euler angles of the second device relative to the first device.

25. The first device of claim 7, wherein: (i) the first device is a source computing device configured to generate data indicative of a virtual reality presentation, and (ii) the second device is a head-mounted device having a display configured to output at least a portion of the virtual reality presentation to a user of the second device.

26. The first device of claim 7, wherein the feedback (i) is generated by one or more sensors coupled to the second device and (ii) is indicative of a position and an orientation of a head of the user of the second device.

27. The first device of claim 7, wherein the feedback is indicative of a position and an orientation of at least one antenna of the second device relative to a position and an orientation of the at least the first antenna or the second antenna of the first device.

28. The first device of claim 7, wherein the first antenna of the first device comprises a first phased array antenna and at least one antenna of the second device comprises a second phased array antenna.

29. A communications device, comprising:
means for generating, by the communications device having at least a first antenna, a first transmission radiation profile for the first antenna;
means for receiving, by the communications device, feedback from a second device that is indicative of a position and an orientation of the second device relative to the first device, the position and the orientation described by one or more Euler angles;
means for comparing, by the communications device, the feedback received from the second device to a predetermined threshold for a trigger event that initiates beamforming by at least one antenna element of a second antenna of the first device; and
means for generating, by the communications device, a second transmission radiation profile for a second antenna of the first device based at least in part on the feedback satisfying the predetermined threshold.

30. A non-transitory computer-readable medium storing code for wireless communication, the code comprising instructions executable to:
generate, by a first device having at least a first antenna, a first transmission radiation profile for the first antenna;
receive, by the first device, feedback from a second device that is indicative of a position and an orientation of the second device relative to the first device, the position and the orientation described by one or more Euler angles;
compare, by the first device, the feedback received from the second device to a predetermined threshold for a trigger event that initiates beamforming by at least one antenna element of a second antenna of the first device; and
generate, by the first device, a second transmission radiation profile for a second antenna of the first device based at least in part on the feedback satisfying the predetermined threshold.
